(19) United States
(12) Patent Application Publication
(10) Pub. No.: US 2014/0046510 A1
(43) Pub. Date: Feb. 13, 2014

(54) ESTIMATING A WIND VECTOR

(71) Applicants: Michael S. Randolph, Johnson City, NY (US); Joseph J. Saunders, Owego, NY (US); Andrew F. Schaefer, Binghamton, NY (US)

(72) Inventors: Michael S. Randolph, Johnson City, NY (US); Joseph J. Saunders, Owego, NY (US); Andrew F. Schaefer, Binghamton, NY (US)

(73) Assignee: Lockheed Martin Corporation, Bethesda, MD (US)

(21) Appl. No.: 13/584,728

(22) Filed: Aug. 13, 2012

(51) Int. Cl. G01C 23/00

(52) U.S. Cl. 701/14

(57) ABSTRACT

Methods and devices for calculating an estimate of a wind vector. A maneuver of a platform may be identified as a steady-straight motion maneuver, a partial turn maneuver, or a full turn maneuver. A preliminary estimate of a wind vector corresponding to a wind condition prevailing near the platform may be calculated by applying a maneuver-specific calculating method. A gain associated with the preliminary estimate of the wind vector may be calculated by applying a state-specific calculation method. A filtered estimate of the wind vector may be updated based, at least in part, on the preliminary estimate of the wind vector and the gain associated with the to preliminary estimate of the wind vector.

### BACKGROUND

This disclosure relates to devices and methods for accurately estimating wind speed and direction. Failure to account for wind may have detrimental effects on aircraft performance, up to and including loss of control, especially in operations close to the ground (i.e. takeoffs and landings). Such outcomes may be mitigated or avoided, at least in some cases, if accurate estimates of wind speed and direction are obtained.

Many types of aircraft are known, including aerostats (i.e., aircraft that are lighter than air, such as hot-air balloons), fixed-wing aircraft (e.g., gliders, propeller-based airplanes, and jets), and rotorcraft (e.g., helicopters). An aircraft may be controlled by a human operator (i.e., a pilot) or by a computer, and may also be “manned” (i.e., a pilot is located on the aircraft) or “unmanned” (i.e., the aircraft is controlled by a computer or by a pilot located remotely from the aircraft). An unmanned aircraft may be referred to as an unmanned aerial vehicle (UAV).

The position or motion of an aircraft may be characterized using one or more terms of art, such as ground track, ground speed, ground vector, heading, true heading, drift angle, crab angle, air track, airspeed, air vector, true airspeed, sideslip, and wind. An aircraft's “ground track” may be characterized as the aircraft's movement with respect to the ground. The rate of an aircraft's movement relative to the ground may be characterized as its “ground speed.” An aircraft's “ground vector” may comprise its ground track and ground speed. An aircraft's “heading” may be characterized as the direction (relative to either true or magnetic north) in which the aircraft's longitudinal axis points. When the heading is referenced to true north, it may be characterized as a “true heading,” and when heading is referenced to magnetic north it may be characterized as “magnetic heading.” The aircraft's “drift angle” or “crab angle” may be characterized as the angle between the aircraft's ground track and its heading. The aircraft's movement with respect to an air mass may be characterized as its “air track,” and the rate of the aircraft's movement with respect to an air mass may be characterized as its “airspeed.” An aircraft's “air vector” may comprise its air track and air speed. When corrected for some atmospheric conditions surrounding the aircraft, measured airspeed may be characterized as “true airspeed.” When an aircraft moves sideways as well as forward relative to an air mass, the aircraft may be said to be in “sideslip.” “Wind” may be characterized as the motion of an air mass with respect to the ground. While the foregoing characterizations are intended to assist the reader in understanding the concepts associated with these terms of art, the meanings of these terms are well-understood to one of ordinary skill in the art.

A wind vector may be a characterization of wind comprising a wind speed and a wind direction. A wind vector may be represented as a single vector in a two-dimensional (2D) or three-dimensional (3D) space, or as a set of mutually orthogonal component vectors. FIG. 1 illustrates alternative representations of a wind vector. In the illustration of FIG. 1, the wind is blowing east-northeast at 40 knots. Accordingly, the corresponding wind vector may be represented as a single vector 100 with magnitude 40 knots and direction 22.5 degrees north of east, or as a component vectors 110 and 120. Component vector 110 is directed north and has magnitude 15.31 knots, while component vector 120 is directed east and has magnitude 36.96 knots.

Supplying an aircraft with accurate wind vectors may enhance the aircraft's safety and performance. If an aircraft's flight controls are not properly adjusted to account for wind conditions, wind may delay the aircraft's progress, alter the aircraft's course, or cause the aircraft to crash. These undesirable outcomes may be avoided or mitigated if the aircraft's operator obtains accurate measurements of wind speed and direction, and uses those measurements to adjust the aircraft's heading, orientation, speed, etc.

One conventional technique for measuring wind vectors is dead reckoning navigation. The concepts underlying dead reckoning navigation are illustrated in FIG. 2, which depicts a wind triangle 200. The three sides of the wind triangle 200 are formed by a ground vector 202, an air vector 204, and a wind vector 206. The angle 208 between the air vector 202 and the ground vector 204 is the drift angle. As shown in FIG. 2, the difference between an aircraft's air vector 202 and ground vector 204 is a wind vector 206. Accordingly, a wind vector 206 may be estimated by measuring an aircraft's air vector 204 and ground vector 202, and subtracting the ground vector 202 from the air vector 204.

As described above, an aircraft's air vector 202 comprises the aircraft's airspeed and air track. Airspeed may be measured by sensors attached to the aircraft, such as pitot tubes. Pitot tubes use pressure measurements to detect rates of fluid flow. In particular, a pitot tube measures the rate at which a fluid flows into the tube in the direction of the tube's longitudinal axis. Thus, a pitot tube aligned with an aircraft's longitudinal axis may detect the rate of an air mass's movement in the direction of the aircraft's longitudinal axis. An aircraft's ground vector 204 may be derived from data of a positioning system, such as the global positioning system (GPS). Alternatively, the ground vector 204 may be obtained by other means, such as measuring the time required to fly from a position above a first known location to a position above a second known location.

Using the wind triangle 200, the north and east components of the wind vector 206 may be computed as follows:

NorthWindSpeed=mag(GroundVector)*cos(angle(GroundVector))−mag(AirVector)*cos(angle(AirVector)) [1],

EastWindSpeed=mag(GroundVector)*sin(angle(GroundVector))−mag(AirVector)*sin(angle(AirVector)) [2],

where mag(x) denotes the magnitude of vector x, and angle(x) denotes the direction of vector x.

Likewise, the component wind vectors may be combined into a single wind vector as follows:

WindSpeed=\sqrt{EastWindSpeed²+NorthWindSpeed²} [3],

WindDirection=tan⁻¹(EastWindSpeed,NorthWindSpeed) [4].

When an aircraft flies with negligible acceleration and negligible change in direction, the aircraft's flight may be characterized as “steady-state.” When an aircraft flies with negligible acceleration, change in direction, and change in altitude, the aircraft's flight may be characterized as “steady-straight.”

### SUMMARY

According to an embodiment of the present disclosure, there is provided a method of calculating an estimate of a wind vector. The method may comprise identifying, with a processor, a maneuver of a platform, wherein the identified maneuver comprises one of a steady-straight motion maneuver, a partial turn maneuver, or a full turn maneuver; calculating, with a processor, a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver; calculating, with a processor, a gain associated with the preliminary estimate of the wind vector, the calculating of the gain associated with the preliminary estimate of the wind vector comprising applying a gain calculation process associated with a state of the aircraft; and updating, with a processor, a filtered estimate of the wind vector based, at least in part, on the preliminary estimate of the wind vector and the gain associated with the preliminary estimate of the wind vector.

In some embodiments of the method, the state of the aircraft may comprise the identified maneuver, an estimated error in the preliminary estimate of the wind vector, one or more maneuvers previously performed by the aircraft, and/or conditions experienced by the aircraft.

In some embodiments of the method, identifying the maneuver of the platform as the partial turn maneuver may comprise: detecting, at a first time, that each of a ground track turn acceleration of the platform, a ground track turn rate of the platform, and an average true airspeed of the platform is within a respective specified range; detecting, at a second time, that the platform is not performing a turn; and calculating that a change in a heading of the platform between the second time and the first time is less than 2π radians.

In some embodiments of the method, identifying the maneuver of the platform as the full turn maneuver may comprise: detecting, at a first time, that each of a ground track turn acceleration of the platform, a ground track turn rate of the platform, and an average true airspeed of the platform is within a respective specified range; and calculating that a change in a heading of the platform between a second time and the first time is approximately 2π radians.

Some embodiments of the method may further comprise: calculating, with a processor, a preliminary estimate of an orthogonal wind vector, the orthogonal wind vector corresponding to a wind condition prevailing near the platform and corresponding to a direction orthogonal to a direction of the preliminary estimate of the wind vector, the calculating of the preliminary estimate of the orthogonal wind vector comprising applying the wind estimation process associated with the identified maneuver to one or more measurements collected during the identified maneuver; calculating, with a processor, a gain associated with the preliminary estimate of the orthogonal wind vector, the calculating of the gain associated with the preliminary estimate of the orthogonal wind vector comprising applying the gain calculation process associated with the state of the aircraft; and updating, with a processor, a filtered estimate of the orthogonal wind vector based, at least in part, on the preliminary estimate of the orthogonal wind vector and the gain associated with in the preliminary estimate of the orthogonal wind vector.

In some embodiments of the method, the gain associated with the preliminary estimate of the wind vector may depend, at least in part, on the estimated error in the preliminary estimate of the wind vector, and the estimated error depends, at least in part, on a type of the identified maneuver.

In some embodiments of the method, the identified maneuver may comprise the partial turn maneuver, the estimated error in the preliminary estimate of the wind vector may further depend, at least in part, on an estimate of a fit between data associated with the partial turn maneuver and data associated with a full turn maneuver, and the estimate of the fit may depend on a percentage of a full turn associated with the partial turn maneuver and on a phase of the full turn associated with the partial turn maneuver.

In some embodiments of the method, the data associated with the full turn maneuver may depend on the platform.

According to another embodiment of the present disclosure, there is provided an apparatus for estimating a wind vector, the apparatus comprising: a processor; and a memory storing instructions which, when executed, cause the processor to perform a method of: identifying a maneuver of a platform, wherein the identified maneuver comprises one of a steady-straight motion maneuver, a partial turn maneuver, or a full turn maneuver; calculating a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver; calculating a gain associated with the preliminary estimate of the wind vector, the calculating of the gain associated with the preliminary estimate of the wind vector comprising applying a gain calculation process associated with a state of the aircraft; and updating a filtered estimate of the wind vector based, at least in part, on the preliminary estimate of the wind vector and the gain associated with the preliminary estimate of the wind vector.

In some embodiments of the apparatus, the state of the aircraft may comprise the identified maneuver, an estimated error in the preliminary estimate of the wind vector, one or more maneuvers previously performed by the aircraft, and/or conditions experienced by the aircraft.

In some embodiments of the apparatus, identifying the maneuver of the platform as the partial turn maneuver may comprise: detecting, at a first time, that each of a ground track turn acceleration of the platform, a ground track turn rate of the platform, and an average true airspeed of the platform is within a respective specified range; detecting, at a second time, that the platform is not performing a turn; and calculating that a change in a heading of the platform between the second time and the first time is less than 2π radians.

In some embodiments of the apparatus, the gain associated with the preliminary estimate of the wind vector may depend, at least in part, on the estimated error in the preliminary estimate of the wind vector, and the estimated error may depend, at least in part, on a type of the identified maneuver.

In some embodiments of the apparatus, the identified maneuver may comprise the partial turn maneuver, the estimated error in the preliminary estimate of the wind vector further may depend, at least in part, on an estimate of a fit between data associated with the partial turn maneuver and data associated with a full turn maneuver, and the estimate of the fit may depend on a percentage of a full turn associated with the partial turn maneuver and on a phase of the full turn associated with the partial turn maneuver.

In some embodiments of the apparatus, the data associated with the full turn maneuver may depend on the platform.

According to another embodiment of the present disclosure, there are provided one or more computer-readable storage media storing instructions for controlling a computer to perform a method comprising: identifying a maneuver of a platform, wherein the identified maneuver comprises one of a steady-straight motion maneuver, a partial turn maneuver, or a full turn maneuver; calculating a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver; calculating a gain associated with the preliminary estimate of the wind vector, the calculating of the gain associated with the preliminary estimate of the wind vector comprising applying a gain calculation process associated with a state of the aircraft; and updating a filtered estimate of the wind vector based, at least in part, on the preliminary estimate of the wind vector and the gain associated with the preliminary estimate of the wind vector.

In some embodiments of the one or more computer-readable storage media, the state of the aircraft may comprise the identified maneuver, an estimated error in the preliminary estimate of the wind vector, one or more maneuvers previously performed by the aircraft, and/or conditions experienced by the aircraft.

In some embodiments of the one or more computer-readable storage media, identifying the maneuver of the platform as the partial turn maneuver may comprise: detecting, at a first time, that each of a ground track turn acceleration of the platform, a ground track turn rate of the platform, and an average true airspeed of the platform is within a respective specified range; detecting, at a second time, that the platform is not performing a turn; and calculating that a change in a heading of the platform between the second time and the first time is less than 2π radians.

In some embodiments of the one or more computer-readable storage media, the gain associated with the preliminary estimate of the wind vector may depend, at least in part, on the estimated error in the preliminary estimate of the wind vector, and the estimated error may depend, at least in part, on a type of the identified maneuver.

In some embodiments of the one or more computer-readable storage media, the identified maneuver may comprise the partial turn maneuver, the estimated error in the preliminary estimate of the wind vector may further depend, at least in part, on an estimate of a fit between data associated with the partial turn maneuver and data associated with a full turn maneuver, and the estimate of the fit may depend on a percentage of a full turn associated with the partial turn maneuver and on a phase of the full turn associated with the partial turn maneuver.

In some embodiments of the one or more computer-readable storage media, the data associated with the full turn maneuver may depend on the platform.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of a wind vector;

FIG. 2 is an illustration of a wind triangle, which depicts the relationships among an air vector, a ground vector, and a wind vector;

FIG. 3 is an illustration of a 2nd-order filter suitable for filtering airspeed measurements to produce airspeed data for a dead reckoning algorithm;

FIG. 4 is a block diagram of an exemplary embodiment of a wind estimation unit;

FIG. 5 is a block diagram of an exemplary embodiment of an estimation unit;

FIG. 6 is an illustration of the magnitudes of an exemplary sequence of north component wind vectors;

FIG. 7 is a schematic illustration of an exemplary embodiment of a computer;

FIG. 8 is a flow chart of an exemplary process for creating a lookup table for estimating an error in the preliminary estimate of a wind vector;

FIG. 9 is a flow chart of an exemplary process for calculating an estimate of a wind vector;

FIG. 10 is a flow chart of an exemplary process for identifying a maneuver of an aircraft as a partial turn maneuver;

FIG. 11 is a flow chart of an exemplary process for identifying a maneuver of an aircraft as a full turn maneuver; and

FIG. 12 is a flow chart of another exemplary process for calculating an estimate of a wind vector.

### DETAILED DESCRIPTION

Embodiments of the present disclosure may relate to estimating a wind vector. The inventors have recognized and appreciated that dead reckoning navigation may produce inaccurate estimates of wind vectors. The accuracy of the dead reckoning algorithm's output (i.e., the wind vector) is, in general, not resilient to inaccuracies in the algorithm's inputs (i.e., the air and ground vectors). Yet, conventional means for measuring an aircraft's airspeed (i.e., pitot tubes) may produce inaccurate airspeed measurements in a wide variety of circumstances. For example, the inventors have recognized and appreciated that pitot tubes may not accurately measure airspeed when an aircraft is in sideslip. When the aircraft is in sideslip, fixed pitot tubes, which are typically aligned with the aircraft's longitudinal axis, may not point directly into the relative wind produced by the aircraft's motion through the surrounding air mass. Thus, during sideslip, the pitot tubes may measure a vector component of the airspeed that is determined by the aircraft's drift angle, rather than the full magnitude of the airspeed in the direction of the aircraft's heading. Inaccuracies associated with pitot tubes may be particularly acute in rotorcraft, which experience inherent sideslip due to tail rotor thrust. Furthermore, inaccuracies in airspeed measurements caused by sideslip may be difficult to correct, because sideslip itself may be difficult to quantify unless expensive instruments are used.

Pitot tubes may also produce inaccurate airspeed measurements when the airspeed is low (e.g., below 50 knots), or when the pitot tube is misaligned with respect to the aircraft's longitudinal axis and/or heading sensor. In addition, wind shear, wind gusts, and changes in the aircraft's speed, direction, or altitude may lead to noisy or inaccurate airspeed measurements.

The accuracy of the dead reckoning algorithm may be improved by identifying conditions associated with inaccurate airspeed measurements, and discounting (e.g., discarding or according low weight to) some or all airspeed measurements collected under such conditions. For example, some of the above-mentioned sources of inaccuracy may be avoided or mitigated by applying the dead reckoning algorithm to airspeed samples only when the aircraft is flying in a “steady-straight” manner and the airspeed samples indicate that the airspeed is greater than some threshold speed, such as 50 knots.

In addition, filtering the airspeed measurements may reduce the impact of noisy samples, such as the samples associated with gusts, shear, and sideslip, and/or samples collected under non-ideal conditions. For example, an Nth-order order filter may be used to calculate an airspeed datum (i.e., an airspeed value provided as an input to the dead reckoning algorithm) by adding the weighted values of N+1 airspeed measurements and N previous filter outputs. The weights applied to the filter inputs (i.e., the airspeed measurements and the previous filter outputs) may be constant or may be dynamically updated to reflect the system's confidence (or lack thereof) in the accuracies of the filter inputs.

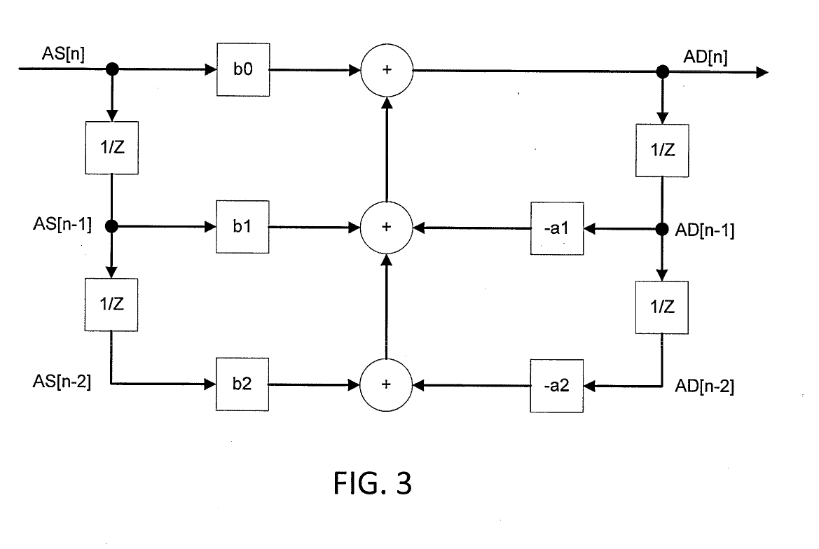

FIG. 3 illustrates an exemplary 2nd-order filter. The filter of FIG. 3 calculates the value of a current airspeed datum as follows:

AD[n]=b0*AS[n]+b1*AS[n−1]+b2*AS[n−2]−a1*AD[n−1]−a2*AD[n−2] [5],

where AD[n] represents the n-th airspeed datum (i.e., airspeed value produced by the filter), AS[n] represents the n-th airspeed sample (i.e., airspeed value measured by the pitot tubes), and filter coefficients b0, b1, b2, a1, and a2 represent the weights assigned to the corresponding airspeed values. If, for example, confidence in the accuracies of the three most recent airspeed samples (AS[n], AS[n−1], and AS[n−2]) and the most recent airspeed data (AD[n−1], AD[n−2]) is high, the filter could be configured to smooth out noise by computing a running average of the three most recent airspeed samples and the most recent airspeed data (e.g., by setting filter coefficients b0, b1, and b2 to 0.2, and setting filter coefficients a1 and a2 to −0.2). On the other hand, if confidence in the most recent airspeed samples is low, but confidence in the most recent airspeed data is high (e.g., because the aircraft recently entered a state of sideslip), the filter could be configured to give greater weight to the most recent airspeed data than to the most recent airspeed samples (e.g., by setting filter coefficients b0, b1, and b2 to 0.01, setting filter coefficient a1 to −0.27, and setting filter coefficient a2 to −0.70). Conversely, if confidence in the most recent airspeed samples is high, but confidence in the most recent airspeed data is low (e.g., because the aircraft recently changed altitude), the filter could be configured to give greater weight to the most recent airspeed samples than to the most recent airspeed data (e.g., by setting filter coefficients b0, b1, and b2 to ⅓, and setting filter coefficients a1 and a2 to 0.0).

The exemplary 2nd-order digital filter of FIG. 3 is depicted in a Direct I configuration. Though, an Nth-order digital filter may be implemented via a Direct I configuration, a Direct II configuration, a DSP processor, software executing on a microprocessor, or any other means known to one of ordinary skill in the art or otherwise suitable for implementing an Nth-order digital filter. Embodiments are not limited in this regard.

While discarding airspeed samples collected under non-ideal conditions and/or filtering airspeed samples may improve the accuracy of the dead reckoning algorithm in some cases, these techniques also introduce new problems. For example, if airspeed samples not acquired during steady-straight flight are discarded, the aircraft's wind estimate may not be updated while the aircraft is performing a maneuver, changing altitude, accelerating, turning, etc. Aircraft that do not spend large amounts of time in steady-straight flight may be presented with stale wind vector data, because the dead reckoning algorithm may update the wind vector infrequently when airspeed samples are discarded in this manner. As another example, an Nth-order filter introduces additional delay between sampling the airspeed and updating the wind vector to reflect the most recent airspeed samples, even when the samples are accurate. Thus, when the wind conditions around the aircraft are changing, the filter may respond to those changes sluggishly, yielding stale wind vectors.

As yet another example, a filter may not screen out all unreliable airspeed samples. Some aircraft are not equipped to detect sideslip, and even if sideslip is detected, some aircraft may not be equipped to measure or otherwise quantify the sideslip component. Such aircraft therefore may not adjust the filter to screen out airspeed samples collected during sideslip. This problem is particularly acute for some rotorcraft, which may frequently fly in a state of sideslip. Also, even when conditions that give rise to inaccurate airspeed samples can be identified, those conditions may not be identified until the filter has already processed some inaccurate airspeed samples, thereby contaminating the airspeed data.

Thus, practical techniques are needed for estimating wind vectors accurately under real-world flight conditions, even if the aircraft is in a state associated with inaccurate airspeed measurements, and for updating wind vector estimates rapidly when wind conditions around the aircraft change. Aircraft could benefit greatly from wind vector estimates that remain accurate and stable (e.g., insensitive to noisy measurements) without becoming stale.

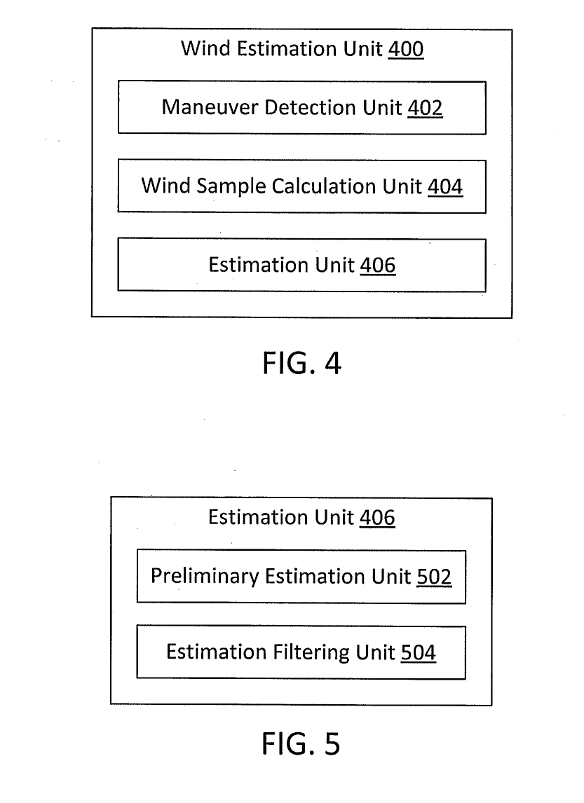

FIG. 4 is a block diagram of an exemplary embodiment of a wind estimation unit 400. In the example of FIG. 4, the wind estimation unit comprises a maneuver detection unit 402, a wind sample calculation unit 404, and an estimation unit 406.

Maneuver Detection

Maneuver detection unit 402 may identify a maneuver performed by an aircraft, such as a full turn, a partial turn, or steady-straight flight. In some embodiments, maneuver detection unit 402 may detect other flight maneuvers known to one of ordinary skill in the art, such as rolls, slips, spins, and stalls. In some embodiments, maneuver detection unit 402 may detect that an aircraft is performing a particular maneuver when the values of one or more flight parameters are within specified ranges. Furthermore, some embodiments may detect that an aircraft is entering a maneuver when the values of one or more corresponding flight parameters change from values outside the specified ranges to values within the specified ranges. Likewise, some embodiments may detect that an aircraft is exiting a maneuver when the values of one or more corresponding flight parameters change from values within the specified ranges to values outside the specified ranges. Flight parameters may include any data associated with the aircraft's flight, such as ground track turn rate, ground track turn acceleration, drift angle, vertical velocity, airspeed, true airspeed, roll rate, pitch rate, turn rate, air acceleration, true air acceleration, turn acceleration, heading, and/or any other data known to one of ordinary skill in the art or otherwise suitably associated with the aircraft's flight.

For example, embodiments of maneuver detection unit 402 may detect that an aircraft is performing a turn when a ground track turn acceleration of the aircraft is within a specified range (e.g., less than 0.025 radians/second²), a ground track turn rate of the aircraft is within a specified range (e.g., greater than 0.01 radians/second), and an average true airspeed of the aircraft is within a specified range (e.g., greater than 40.0 or 50.0 knots). Though, the turn parameters and ranges described above are illustrative, not limiting. Embodiments of maneuver detection unit 402 may detect that an aircraft is in a turn using any parameter measurements and ranges known to one of ordinary skill in the art or otherwise suitable for detecting that an aircraft is in a turn.

As another example, embodiments of maneuver detection unit 402 may detect that an aircraft is entering a turn at a time when values of one or more flight parameters change from values outside specified ranges to values within specified ranges. For example, if average true airspeed of the aircraft is already within the specified range, and ground track turn rate of the aircraft is already greater than 0.01 radians/second, embodiments of maneuver detection unit 402 may detect the entering of a turn at a time when the aircraft's ground track turn acceleration decreases from a value greater than 0.025 radians/second² to a value less than 0.025 radians/second². Likewise, some embodiments of maneuver detection unit 402 may detect that an aircraft is exiting a turn at a time when values of one or more flight parameters change from values within specified ranges to values outside specified ranges. For example, if the above-described parameter values are all within the above-described ranges, and the average true airspeed of the aircraft drops below the specified range, embodiments of maneuver detection unit 402 may detect that the aircraft is exiting the turn.

In some embodiments, maneuver detection unit 402 may rely on heading data to classify a turn as either a partial turn or a full turn. Embodiments of maneuver detection unit 402 may detect that a turn is a full turn if the aircraft's heading changes by 2π radians (i.e., moves away from some value and then returns to the same value) while the aircraft remains in the turn. That is, embodiments may detect a full turn if the cumulative angle of the turn approaches or exceeds 2π radians. Likewise, embodiments of maneuver detection unit 402 may detect that a turn is a partial turn if, between the time the aircraft enters the turn and the time the aircraft exits the turn, the aircraft's heading changes by less than 2π radians. That is, embodiments may detect a partial turn if the cumulative angle of the turn is less than approximately 2π radians.

In some embodiments, maneuver detection unit 402 may require additional constraints to be satisfied when classifying a non-full turn as a partial turn. In some embodiments, a non-full turn may be classified as a partial turn only if, in addition to satisfying the constraints on average true airspeed, ground track turn rate, and ground track turn acceleration associated with full turns, the aircraft satisfies these additional constraints: true airspeed acceleration less than 8.42 knots/s, turn acceleration less than 0.05 degrees/second², and vertical velocity less than 5 feet/second.

As another example, embodiments of maneuver detection unit 402 may detect that an aircraft is in steady-straight flight when a ground track turn rate, a drift angle, a vertical velocity, a true airspeed, a roll rate, a pitch rate, a turn rate, a true airspeed acceleration, and a ground track turn acceleration are within specified ranges (e.g., less than 0.005 radians/second, less than 5°, less than 2 feet/second, greater than 55 knots, less than 0.01 radians/second, less than 0.01 radians/second, less than 0.005 radians/second, less than 8.439 knots/second, and less than 0.05 radians/second², respectively). Alternatively or additionally, some embodiments of detection unit 402 may detect that an aircraft is in steady-straight flight when a ground track turn rate, a drift angle, a vertical velocity, a true airspeed, a roll rate, a pitch rate, a turn rate, and a ground track turn acceleration are within other specified ranges (e.g., less than 0.0005 radians/second, less than 5°, less than 1 foot/second, greater than 55 knots, less than 0.0005 radians/second, less than 0.0005 radians/second, less than 0.0005 radians/second, and less than 0.0005 radians/second², respectively). Alternatively or additionally, some embodiments of detection unit 402 may detect that an aircraft is in steady-straight flight when a ground track turn rate, a drift angle, a vertical velocity, and a true airspeed are within other specified ranges (e.g., less than 0.21 radians/second, less than 20°, less than 8.333 feet/second, and greater than 50 knots, respectively). The steady-straight flight parameters and ranges described above are illustrative, not limiting. Embodiments of maneuver detection unit 402 may detect that an aircraft is in steady-straight flight using any parameter measurements and ranges known to one of ordinary skill in the art or otherwise suitable for detecting that an aircraft is in steady-straight flight.

In some embodiments, the airspeed constraints associated with a given maneuver (e.g., 40 or more knots for a partial or full turn, and 55 or more knots for steady-straight flight) may relate to conditions under which airspeed is estimated with sufficient accuracy. In general, airspeed instruments (e.g., pitot tubes) may consistently provide accurate airspeed samples when the airspeed is 55 or more knots. Thus, if a first airspeed estimation method is fairly sensitive to the accuracies of the individual airspeed samples, applying the first airspeed estimation method to airspeed samples collected at airspeeds lower than 55 knots may yield an inaccurate airspeed estimate. By contrast, if a second airspeed estimation method is less sensitive to the accuracies of the individual airspeed samples, applying the second airspeed estimation method to airspeed samples collected at airspeeds somewhat lower than 55 knots may still yield an accurate airspeed estimate—even if some subset of the individual airspeed samples are inaccurate. More generally, the accuracy with which airspeed is estimated from a set of airspeed samples may depend on the airspeed at which the samples are collected, the aircraft collecting the samples, and/or the airspeed estimation method applied to the samples. Thus, the airspeed constraints associated with detection of a maneuver may depend on the aircraft performing the maneuver and/or the airspeed estimation method associated with the maneuver.

Maneuver detection unit 402 may obtain values of flight parameters using techniques known to one of ordinary skill in the art or any other suitable techniques. In some embodiments, maneuver detection unit 402 may comprise sensors for sampling the values of the flight parameters that are used to identify the maneuvers performed by the aircraft. In some embodiments, maneuver detection unit 402 may obtain the values of the above-described flight parameters from external sensors (e.g., via an input/output interface), from one or more external sensor controllers (e.g., via a network interface), or from a memory. Embodiments are not limited in this regard.

Irrespective of how maneuver detection unit 402 obtains values of flight parameters, embodiments of maneuver detection unit 402 may send control signals to the sensors or sensor controller(s) indicating rates at which certain flight parameters should be sampled. For example, an embodiment of maneuver detection unit 402 that is configured to detect only turns may send control signals indicating that samples of ground track turn acceleration, ground track turn rate, and true airspeed are to be obtained at a rate of 1 Hz. When an embodiment of maneuver detection unit 402 detects that the aircraft is entering a turn, it may send a control signal indicating that samples of the aircraft's heading should be obtained at a suitable rate. Likewise, when an embodiment of maneuver detection unit 402 detects that the aircraft is exiting a turn, it may send a control signal indicating that it no longer requires samples of the aircraft's heading. Though, embodiments are not limited in this regard. In some embodiments, maneuver detection unit 402 may obtain samples of various flight parameters at specified rates, irrespective of any maneuver being entered, exited, performed, or not performed at the times the parameters are sampled.

Values of flight parameters may be measured (“sampled”) using techniques and/or devices known to one of ordinary skill in the art or otherwise suitable for measuring flight parameters. For example, airspeed measurements may be obtained via pitot tubes. Measurements related to ground track (e.g., ground track, ground track turn rate, and/or ground track turn acceleration) may be obtained by processing data provided by an Inertial Navigation System (INS) and/or a global positioning system (GPS). Measurements related to acceleration may be obtained via accelerometers. Compass heading measurements may be obtained via a magnetic compass, and true heading data may be obtained by processing compass heading measurements. Such sensors may be deployed at locations on the aircraft known to one of ordinary skill in the art or otherwise suitable for measuring the corresponding flight parameters. Such sensors may be controlled by one or more sensor controllers accessible to wind estimation unit 400 via an input/output interface, a network interface, and/or any other suitable means for accessing a sensing a sensor controller.

Wind Sample Calculation

Wind sample calculation unit 404 may use flight parameter values provided by sensors and/or sensor controller(s) to calculate wind vector samples. Embodiments of wind sample calculation unit 404 may store at least some of the calculated wind vector samples in a memory and/or make at least some of the wind vector samples available to estimation unit 406 using any other suitable means.

In some embodiments, wind sample calculation unit 404 may use dead reckoning navigation to calculate the wind vector samples. That is, embodiments of wind sample calculation unit 404 may use the flight parameter values to calculate an air vector (e.g., true heading and airspeed) and a ground vector (e.g., ground track and ground speed), and may calculate the wind vector as the vector difference between the ground vector and the air vector. Though, embodiments are not limited in this regard. Wind sample calculation unit 404 may calculate or otherwise obtain wind vector samples using any means known to one of ordinary skill in the art.

Embodiments of wind sample calculation unit 404 may calculate wind vector samples under any suitable conditions. In some embodiments, wind sample calculation unit 404 may calculate wind vector samples continually, irrespective of any maneuver that the aircraft may or may not be performing. In some embodiments, wind sample calculation unit 404 may calculate wind vector samples only when the aircraft is performing one of a set of designated maneuvers, such as a full turn, a partial turn, or steady-straight flight. In some embodiments, wind sample calculation unit 404 may calculate wind vector samples only using flight parameter values that were measured while the aircraft was performing one of a set of designated maneuvers. Accordingly, embodiments of wind sample calculation unit 404 may receive data from maneuver detection unit 402 indicating when the aircraft entered a maneuver, when the aircraft exited a maneuver, what maneuver the aircraft is currently performing, what maneuver the aircraft was performing at a previous time, etc. Likewise, embodiments of wind sample calculation unit 404 may receive data from sensors and/or sensor controller(s) indicating when flight parameter values were sampled.

Like maneuver detection unit 402, wind sample calculation unit 404 may obtain values of flight parameters using techniques known to one of ordinary skill in the art or any other suitable techniques. In some embodiments, wind sample calculation unit 404 may comprise sensors for sampling the values of the flight parameters that are used to compute the wind vector samples. In some embodiments, wind sample calculation unit 404 may obtain the values of the above-described flight parameters from external sensors (e.g., via an input/output interface), from one or more external sensor controllers (e.g., via a network interface), or from a memory. Embodiments are not limited in this regard.

Irrespective of how wind sample calculation unit 404 obtains values of flight parameters, embodiments of wind sample calculation unit 404 may send control signals to the sensors or sensor controller(s) indicating rates at which certain flight parameters should be sampled. For example, an embodiment of wind sample calculation unit 404 may send control signals indicating that samples of GPS position, airspeed, and heading are to be obtained at a rate of 1 Hz.

Estimation unit 406 may process wind vector samples to estimate a wind vector corresponding to a wind condition prevailing near the aircraft. In some embodiments, at least a portion of the processing performed by estimation unit 406 may be maneuver-specific. That is, embodiments of estimation unit 406 may use different methods to estimate wind vectors from wind vector samples associated with different maneuvers. For example, estimation unit 406 may apply a first estimation method to wind vector samples derived from flight parameter values acquired during a full turn (“wind vector samples corresponding to a full turn”), apply a second estimation method to wind vector samples derived from flight parameter values acquired during a partial turn (“wind vector samples corresponding to a partial turn”), and apply a third estimation method to wind vector samples derived from flight parameter values acquired during steady-straight flight (“wind vector samples corresponding to steady-straight flight”).

In summary, an aircraft may include sensors configured to acquire flight parameter values during an aircraft's flight. The acquired parameters may be suitable for detecting a maneuver of the aircraft and/or calculating a wind vector sample. During a maneuver or when the aircraft exits a maneuver, maneuver detection unit 402 may classify the maneuver (e.g., maneuver detection unit 402 may classify a maneuver as steady-straight flight when the aircraft enters the maneuver, may classify a maneuver as a partial turn when the aircraft exits the maneuver, and/or may classify a maneuver as a full turn when the aircraft is performing a turn and the heading has changed by approximately 2π radians). While the aircraft is performing the maneuver and/or after the aircraft exits the maneuver, wind sample calculation unit 404 may use the flight parameter values associated with the turn to calculate a corresponding sequence of wind vector samples. Estimation unit 406 may rely upon the wind vector samples produced by wind sample calculation unit 404 and the maneuver classification produced by maneuver detection unit 402 to estimate a wind vector.

Estimation

FIG. 5 is a block diagram of an exemplary embodiment of an estimation unit 406. In the example of FIG. 5, the estimation unit comprises a preliminary estimation unit 502 and an estimation filtering unit 504. Preliminary estimation unit 502 may use maneuver-specific processing to calculate a preliminary estimate of a wind vector and an estimated error in the accuracy of the preliminary estimate.

Preliminary Estimation for Full Turns

Techniques for calculating a preliminary estimate of a wind vector corresponding to a full turn or a partial turn may relate to the shape of the aircraft's flight pattern during the turn maneuver. In the absence of any wind, the flight pattern of an aircraft performing a full turn might be a circle or a close approximation thereof. Likewise, without wind, the flight pattern of an aircraft performing a partial turn might closely approximate a portion of the circumference of a circle. On the other hand, in the presence of wind, the flight pattern of an aircraft performing a full turn may approximate a complete cycloid, and the flight pattern of an aircraft performing a partial turn may be approximate a portion of a cycloid.

Accordingly, embodiments of preliminary estimation unit 502 may use mathematical principles relating to cycloids to calculate a preliminary estimate of a wind vector corresponding to a full turn. For example, the preliminary estimate may be calculated by averaging the sequence of wind vector samples corresponding to the full turn. Embodiments of preliminary estimation unit 502 may average the wind vector samples using any technique known to one of ordinary skill in the art or otherwise suitable for calculating an average value of one or more vector quantities. As another example, the wind vector may be estimated as a vector directed from the aircraft's location (e.g., GPS coordinates) at the beginning of the full turn to the aircraft's location at the end of the full turn, having a magnitude equal to the distance between those two locations divided by the time required to complete the full turn.

Applying mathematical principles relating to cycloids may produce a highly accurate preliminary estimate of the wind vector corresponding to a full turn. For example, a wind vector calculated in this manner may be insensitive to sideslip (i.e., the estimated wind vector may be highly accurate even if some of the underlying wind vector samples were derived from flight parameter values that were sampled while the aircraft was in a state of sideslip). This insensitivity to sideslip may arise because averaging a sequence of wind vector samples collected during a full turn cancels out the adverse effects of sideslip on the accuracies of individual wind vector samples. Thus, embodiments of preliminary estimation unit 502 may estimate the error in the accuracy of the preliminary estimate of the wind vector corresponding to a full turn to be low, negligible, or even zero.

Preliminary Estimation for Partial Turns

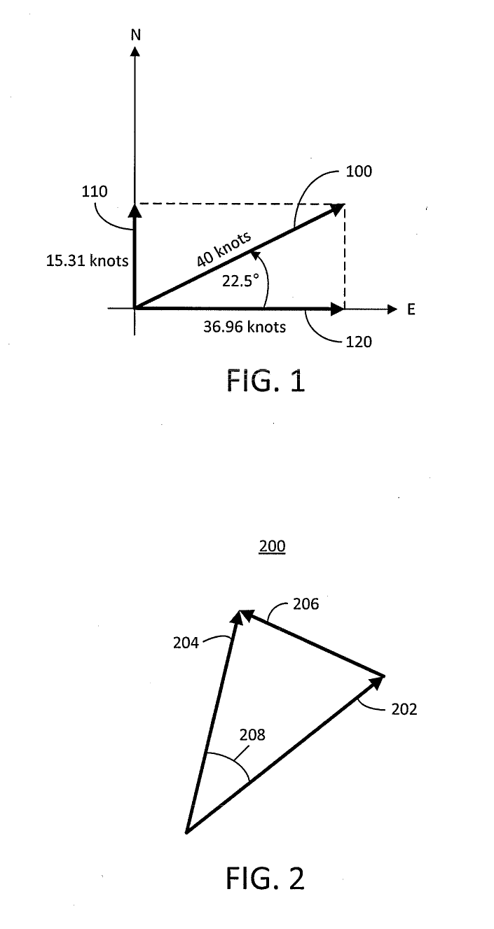

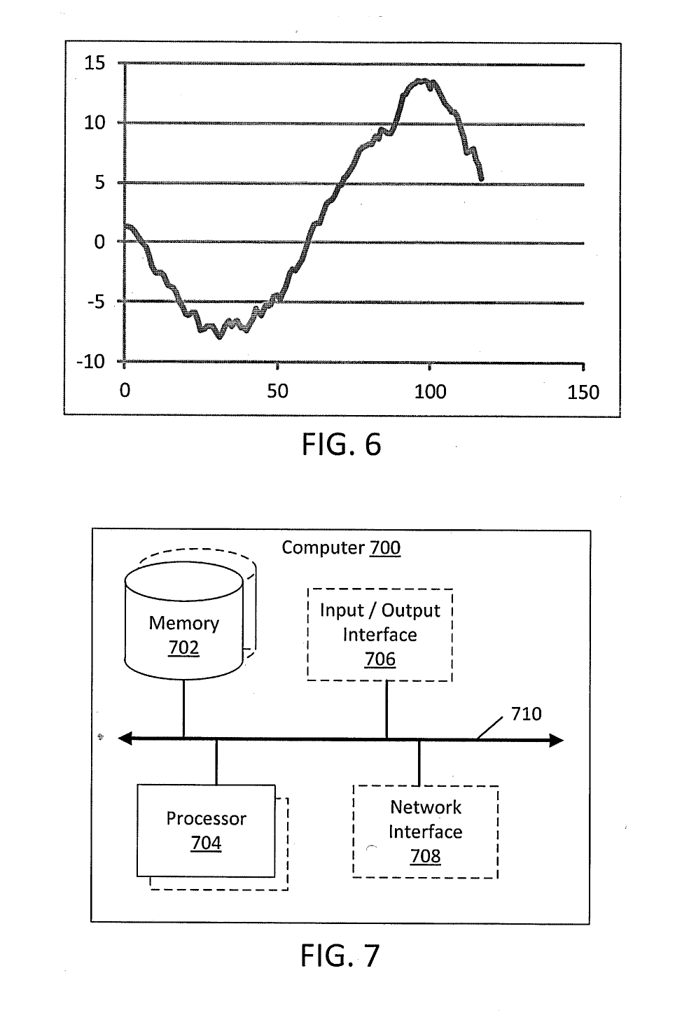

If an aircraft performs a partial turn rather than a full turn, embodiments of preliminary estimation unit 502 may calculate a preliminary estimate of a wind vector by a process of projection and averaging. The projection step may involve fitting a curve to the wind vector samples corresponding to the partial turn. As described above with reference to FIG. 1, a wind vector sample may be represented as orthogonal component vectors, such as a component directed north and a component directed east. Thus, the sequence of wind vector samples corresponding to a full turn may be represented as parallel sequences of north component vectors and east component vectors. FIG. 6 illustrates a graph of the magnitudes (speeds) of an exemplary sequence of north component vectors, with sample time on the horizontal axis and speed on the vertical axis. As FIG. 6 shows, the points in the exemplary north wind sequence form a shape that is roughly sinusoidal. (Though not shown, a graph of the points in an exemplary east wind sequence form a shape that is also roughly sinusoidal, and approximately 90° out-of-phase with respect to the points in the exemplary north wind sequence.)

The roughly sinusoidal shape of FIG. 6 may be typical of wind samples corresponding to a full turn, because airspeed measurements provided by a pitot tube may not account for a component of the wind that does not flow directly into the tube. Thus, when a wind vector is constant and an aircraft performs a full turn, the component of the wind vector flowing into the pitot tube may reach a maximum when the aircraft is flying directly into the wind, decrease as the aircraft turns away from the wind, reach a minimum when the aircraft is flying in the same direction as the wind, and increase as the aircraft turns back into the wind. That is, the magnitude of the component of the wind vector flowing into the pitot tube may vary sinusoidally when the wind vector is constant and the aircraft performs a full turn.

Accordingly, when processing a sequence of wind vector samples corresponding to a partial turn, embodiments of preliminary estimation unit 502 may fit curves to the north and east component speeds of the wind vector samples, thereby approximating the values of the wind vector samples that would have been computed if the aircraft had completed a full turn. Embodiments may fit curves to the north and east component speeds via a least squares estimation (LSE) technique or any other curve fitting technique known to one of ordinary skill in the art or otherwise suitable for fitting a curve to data points that are approximately sinusoidal. In some embodiments, the curve-fitting technique used by preliminary estimation unit 502 may be configured or optimized to fit sinusoidal curves to the north and east component speeds, in accordance with the foregoing.

Embodiments of preliminary estimation unit 502 may then estimate the wind vector corresponding to the partial turn by calculating the average value of the data corresponding to the projected full turn. For example, embodiments may calculate the average value by integrating the fitted curve (e.g., a sinusoid) over an interval equal to its period and dividing the result by the period. As another example, embodiments may construct a sequence of wind vector samples corresponding to the projected full turn, wherein the sequence comprises the wind vector samples corresponding to the partial turn and additional wind vector samples corresponding to the fitted curve, and calculate an average value of the constructed sequence of wind vector samples. Embodiments may average the constructed sequence of wind vector samples using any technique known to one of ordinary skill in the art or otherwise suitable for calculating an average value of one or more vector quantities.

The above-described process of curve-fitting and averaging may produce a preliminary estimate of a wind vector that is highly accurate, though the error associated with the estimate may be non-negligible, at least in some cases. In some embodiments, the accuracy of the wind vector estimate may depend on the completeness of the partial turn (i.e., the proportion of a full turn's circumference traced out by the partial turn). For example, the accuracy of the wind vector estimate may, in general, increase as the completeness of the partial turn increases. In some embodiments, the accuracy of the wind vector estimate may depend on the phase offset of the partial turn (i.e., the initial angle of the sinusoidal fitted curve). For example, if the partial turn is relatively incomplete, and the phase offset is such that the curve-fitting process is applied to points near a peak of a sinusoidal curve, the wind vector estimate may be relatively inaccurate. By contrast, if the partial turn is relatively incomplete and the phase offset is such that the curve-fitting process is applied to points in the transition region of a sinusoidal curve (i.e., points between the sinusoids peaks), the wind vector estimate may be relatively accurate.

Thus, embodiments of preliminary estimation unit 502 may estimate the error in the preliminary estimate of a wind vector corresponding to a partial turn. In some embodiments, the error in the wind vector estimate may be regarded as a function of a “fit error” (i.e., an error associated with a curve-fitting process, such as discrepancy between the actual data and the fitted curve), which may depend on the completeness and the phase offset of the partial turn. For example, if the curve-fitting process fits the north component wind speeds of the partial turn data to a true sinusoid, a fit error between the north component wind speeds and the true sinusoid may be calculated using techniques known to one of ordinary skill in the art. A fit error between the east component wind speeds and the corresponding sinusoid may be calculated in like manner. These fit errors may be used as estimates of the respective errors in the preliminary estimates of the north wind vector and the east wind vector.

Rather than equating the error in the preliminary estimate of a component wind vector to the fit error between the corresponding component wind speeds and a true sinusoid, some embodiments of preliminary estimation unit 502 may use data associated with full turns to more accurately estimate the error in the wind vector estimate for a partial turn. As shown in FIG. 6, component wind speed points corresponding to a full turn may not perfectly fit a true sinusoid. The discrepancies between a full turn's component wind speed points and a true sinusoid may be partially attributed to the effects of flat-plate drag. In particular, flat-plate drag may systematically cause asymmetry in a full turn's component wind speed points. Averaging a full turn's component wind speed points may, in large measure, cancel out the effects of flat-plate drag. By contrast, if a partial turn's component wind speed points are distorted by flat-plate drag, fitting a sinusoid to those points and projecting additional points along the sinusoid may compound, rather than cancel, the distortions. Accordingly, some embodiments of preliminary estimation unit 502 may use a lookup table to estimate the error in the preliminary estimate of a component wind vector.

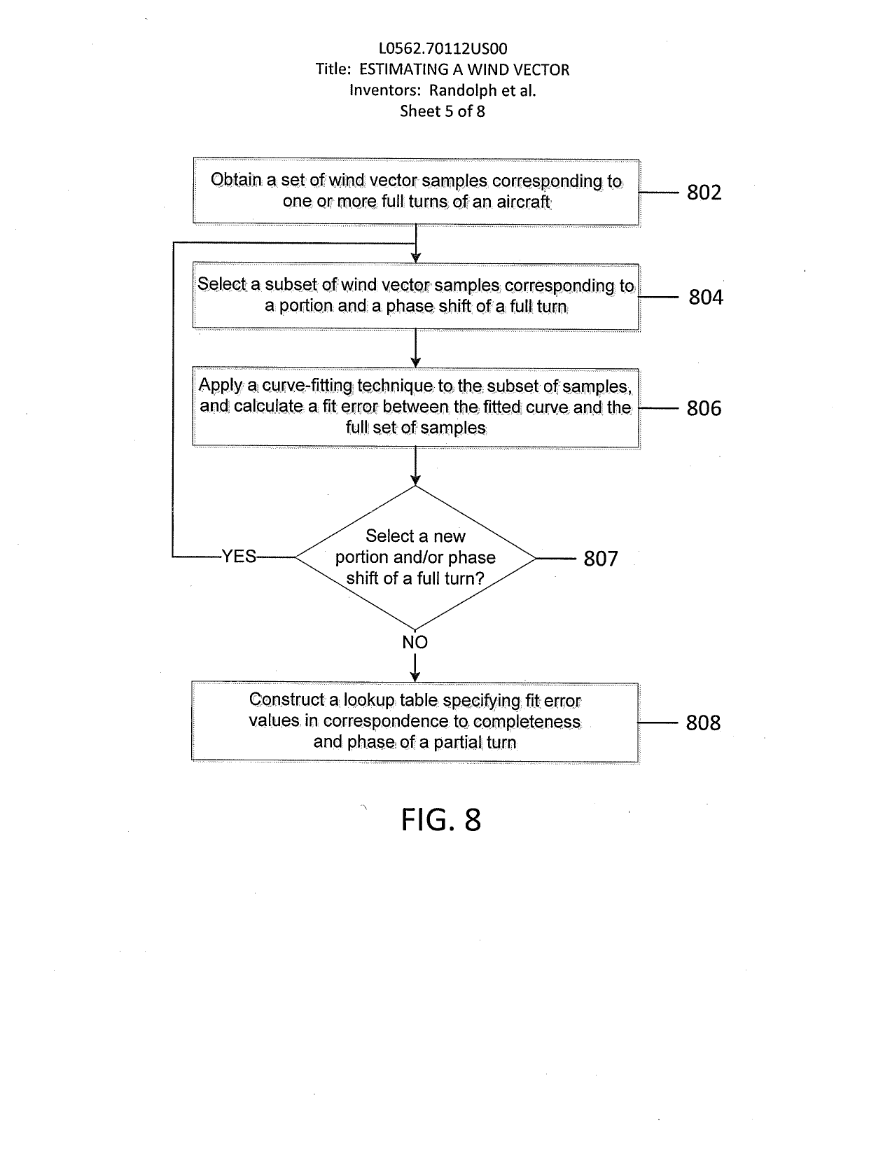

FIG. 8 is a flow chart of an exemplary method for creating a lookup table for estimating an error in the preliminary estimate of a wind vector. At act 802 of the exemplary method, wind vector samples corresponding to one or more full turns of an aircraft may be obtained. In some embodiments, the wind vector samples may be obtained by performing one or more full turns with the aircraft and calculating the wind vector samples with a wind sample calculation unit 404, as described above. In some embodiments, the wind vector samples for one aircraft may be obtained by performing one or more full turns with another aircraft. In some embodiments, wind vector samples may be provided by an entity that previously obtained the samples, such as a manufacturer of the aircraft. In some embodiments, the wind vector samples may be obtained by simulation.

At act 804 of the exemplary method, at least a subset of the full turn's wind vector samples may be selected. In some embodiments, the selected samples may be adjacent (i.e., actually contiguous within the sequence of wind vector samples) or circularly adjacent (i.e., contiguous within the sequence of wind vector samples if the first and last samples are regarded as being adjacent). In some embodiments, the selected samples may correspond to a particular portion (e.g., percentage) of the full turn beginning at a particular phase shift. The percentage of the full turn represented by the selected samples may be calculated in any suitable way, e.g., by dividing the number of selected samples by the total number of samples in the full turn. In the vocabulary of partial turns, the subset of samples may be regarded as wind vector samples corresponding to a “partial turn,” and the “portion” and “phase shift” may be regarded as the partial turn's “completeness” and “phase offset,” respectively.

At act 806 of the exemplary method, a curve-fitting technique may be applied to the subset of samples, and fit error between the fitted curve and the full set of samples may be calculated. More specifically, a curve-fitting technique may be applied to orthogonal components of the subset of samples, and fit errors between the fitted curves and the respective full sets of orthogonal components may be calculated. In some embodiments, the curve-fitting technique and fit-error-calculating technique may be the same curve-fitting technique and fit-error-calculating technique applied by preliminary estimation unit 502 to wind vector samples corresponding to a partial turn. In some embodiments, the fit error may be recorded in correspondence to the “completeness” and “phase offset” of the “partial turn.”

Acts 804 and 806 may be performed for one or more subsets of the wind vector samples associated with one or more full turns, wherein each subset corresponds to a particular “portion” and “phase shift” of the full turn. In this manner, the wind vector samples of the full turn(s) may be used to estimate the fit errors associated with a partial turn of a given completeness and phase offset. In some embodiments, acts 804 and 806 may be performed for all possible subsets of the wind vector samples associated with each of the full turn(s).

At act 808 of the exemplary method, a lookup table of fit error data may be constructed. Each entry of the lookup table may be a fit error value that corresponds to a specified completeness and phase offset of a partial turn. The lookup table may be constructed from the data generated in acts 804 and 806 using techniques known to one of ordinary skill in the art or any other suitable techniques. For example, the lookup table may be constructed such that each row corresponds to a completeness C (e.g., an integer value between 3% and 100%) and each column corresponds to a phase P (e.g., an integer value between −90° and 90°. The data generated in acts 804 and 806 may be assigned to the nearest entry of the lookup table. For example, a fit error F corresponding to a completeness of 5.71% and a phase offset of 89.16° may be assigned to the cell in row C=6% and in column P=89°. If more than one fit error F is assigned to a cell, a representative value for the cell may be selected in any suitable way. For example, average fit error, median fit error, or largest fit error may be selected. The fit error data corresponding to north components of wind samples may be tabulated separately from the fit error data corresponding to east components of wind samples.

Embodiments of preliminary estimation unit 502 may use a lookup table constructed in accordance with the exemplary method of FIG. 8 to estimate the error in the preliminary estimate of a component wind vector corresponding to a partial turn. Some embodiments may calculate the completeness C of the partial turn based on, for example, the turn rate and the period of the turn. In addition, embodiments may calculate the phase offset P of a sequence of the partial turn's component wind samples via a curve-fitting technique, such as least-squares estimation. Having calculated the completeness C and phase offset P, embodiments may retrieve the fit error corresponding to (C, P) from the lookup table corresponding to the component wind samples, and use that fit error as an estimate of the error in the preliminary estimate of the corresponding component wind vector.

In some embodiments, the accuracy of the lookup tables may be enhanced if the lookup tables are aircraft-specific. Flat-plate drag and other aerodynamic phenomena may cause the turn data of different aircraft to deviate from true sinusoids in different ways or to different degrees. Thus, a lookup table created using turn data associated with one aircraft, if subsequently used to estimate errors in wind vectors calculated from turns of the same aircraft, may more accurately estimate errors than if the table is subsequently used to estimate errors in wind vectors calculated from turns of a differently configured aircraft. On the other hand, if two aircraft are similarly configured, a lookup table generated using one aircraft's turn data may accurately estimate errors in wind vectors calculated from turns of the other aircraft. Likewise, if a lookup table generated using turn data acquired from multiple, differently configured aircraft may accurately estimate errors in wind vectors calculated from turns of any of the constituent aircraft.

In summary, embodiments of preliminary estimation unit 502 may calculate a preliminary estimate of a wind vector (or preliminary estimates of orthogonal components of a wind vector) corresponding to a full or partial turn, and may estimate an error in the accuracy of the estimated wind vector (or estimate errors in the accuracies of the estimated orthogonal components of the wind vector). For full turns, embodiments may estimate the error in the accuracy of the estimated wind vector to be negligible, and may send the estimated wind vector (or estimated orthogonal components of the wind vector) to estimation filtering unit 504, along with the negligible or zero estimate of the associated error(s).

For partial turns, embodiments may estimate the error in the accuracy of either orthogonal component of the wind vector to be non-negligible. Some embodiments may send the estimated components and the estimates of the associated errors to estimation filtering unit 504. In some embodiments, an estimated wind vector component and the estimate of the associated error may be sent to estimation filtering unit 504 only if the estimated of the associated error falls below a specified threshold, such as 13%. In some embodiments, the estimated error may be assumed to exceed 13% if the partial turn's completeness is less than 20%. Thus, in some cases, an estimated wind vector component corresponding to a partial turn (e.g., the north wind vector component) may be sent to estimation filtering unit 504, but the other wind vector component corresponding to the same partial turn (e.g., the east wind vector component) may not be sent to estimation filtering unit 504. That is, in conjunction with a partial turn, embodiments of preliminary estimation unit 502 may provide estimation filtering unit 504 with an estimate of a north component vector, an estimate of an east component vector, estimates of both component vectors, or estimates of neither component vector, depending on the corresponding error estimates.

Preliminary Estimation for Steady-Straight Flight

Additionally or alternatively, when an aircraft performs a steady-straight flight maneuver, embodiments of preliminary estimation unit 502 may produce one or more preliminary estimates of wind vectors corresponding to the steady-straight flight. In some embodiments, one or more of the wind vector samples collected by wind sample calculation unit 404 in conjunction with the steady-straight flight maneuver may be sent to estimation filtering unit 504 as one or more preliminary estimates of the wind vector. In other words, during steady-straight flight, embodiments of preliminary estimation unit 502 may pass wind vector samples from wind sample calculation unit 404 to estimation filtering unit 504, without additional filtering or processing.

Embodiments of preliminary estimation unit 502 may estimate the error in the preliminary estimate of a wind vector corresponding to steady-straight flight using techniques known to one of ordinary skill in the art or any other suitable techniques. One the other hand, some embodiments of preliminary estimation unit 502 may not estimate the error in the preliminary estimate of the wind vector.

Estimation Filtering

The exemplary estimation unit 406 of FIG. 5 comprises an estimation filtering unit 504. Estimation filtering unit 504 may use state-specific processing to calculate a filtered estimate (FE) of a wind vector that depends, at least in part, on a preliminary estimate (PE) of the wind vector provided by preliminary estimation unit 502. Under some conditions, the value of the filtered estimate may also depend on a filter gain (K) associated with the preliminary estimate of the wind vector and/or on a previous value of the filtered estimate (PPE). In some embodiments, the estimation filtering process may be state-specific at least in the sense that the filter gain (K) associated with the preliminary estimate may depend on the maneuver corresponding to the preliminary estimate, an estimated error in the preliminary estimate, one or more maneuvers previously performed by the aircraft, and/or conditions experienced by the aircraft (such as environmental conditions). Additionally or alternatively, the estimation filtering process may be state-specific in the sense that a time constant associated with the filter depends on conditions experienced by the aircraft.

In some embodiments, the estimation filtering process may be state-specific in the sense that the inputs to estimation filtering unit 406 may depend on conditions experienced by the aircraft or on commands given by an operator of the aircraft. For example, if the filtered estimate of the wind vector has not been updated within a specified period, or if the operator requests an update to the wind vector, the ranges or thresholds applied by maneuver detection unit 402 to detect a maneuver performed by the aircraft may be dynamically adjusted such that the wind sample calculation unit can more readily obtain new wind vector samples. Likewise, the maneuvers for which the wind sample calculation unit generates new wind vector samples may be adjusted in response to conditions or commands.

For simplicity, the estimation filtering unit 504 is described as producing a filtered estimate FE by performing operations on a preliminary estimate PE and/or a previous filtered estimated PFE. Based on the foregoing, one of ordinary skill in the art will understand that such operations can be performed on vectors which represent net estimates of a wind vector (i.e., FE_{NET}, PE_{NET}, and PFE_{NET}), or on orthogonal vectors which represent components of a wind vector, such as north wind components (i.e., FE_{N}, PE_{N}, and PEE_{N}) and east wind components (i.e., FE_{E}, PE_{E}, and PFE_{E}). For example, if preliminary estimation unit 502 provides a preliminary estimate of a net wind vector (PE_{NET}), embodiments of estimation filtering unit 504 may calculate a filtered estimate of the net wind vector (FE_{NET}). As another example, if preliminary estimation unit 502 provides a preliminary estimate of the north wind vector (PE_{N}), embodiments of estimation filtering unit 504 may calculate a filtered estimate of the north wind vector (FE_{N}). One of ordinary skill in the art will also understand that if preliminary estimation unit 502 provides a preliminary estimate of a net wind vector (PE_{NET}) or preliminary estimates of both a north wind vector (PE_{N}) and an east wind vector (PE_{E}), the preliminary estimation unit 502 may estimate an error associated with the preliminary estimate of the north wind vector to differ from an error associated with the preliminary estimate of the east wind vector.

After obtaining a preliminary estimate of a wind vector corresponding to a full turn, some embodiments of estimation filtering unit 504 may set the value of the filtered estimate to the value of the preliminary estimate (i.e., FE=PE), thereby updating the filtered estimate to a value that depends only on current measurements and not on any stale measurements associated with the previous filtered estimate. Some embodiments may set the value of the filtered estimate to a weighted sum of the preliminary estimate and a previous value of the filtered estimate (i.e., FE=K_{FULL}*PE+(1−K_{FULL})*PFE), thereby updating the filtered estimate to a value that depends not only on current measurements but also on previous measurements that have been incorporated into the previous filtered estimate. The former embodiment may provide wind vector estimates that are highly responsive to changing wind conditions. The latter embodiment may provide wind vector estimates that are highly stable and resilient to transient fluctuation in the wind (e.g., wind gusts). In the latter embodiment, the filter gain K_{FULL}, may be set to a predetermined value or may be calculated using techniques known to one or ordinary skill in the art or any other suitable techniques. Also, in the latter embodiment, if no previous filtered estimate has been provided, the value of the filtered estimate may be set to the value of the preliminary estimate.

After obtaining a preliminary estimate of a wind vector corresponding to a partial turn, some embodiments of estimation filtering unit 504 may set the value of the filtered estimate to a weighted sum of the preliminary estimate and a previous value of the filtered estimate (i.e., FE=K_{PART}*PE+(1−K_{PART})*PFE). In some embodiments, the value of the filter gain K_{PART} may depend on the estimated error in the preliminary estimate. Additionally or alternatively, in some embodiments the value of the filter gain K_{PART} may depend on whether wind vectors corresponding to full turns, partial turns, and/or steady-straight flight have been incorporated into the previous filtered estimate.

If the estimated error associated with the preliminary estimate exceeds a specified threshold (e.g., 13%), some embodiments may set K_{PART} to 0. Equivalently, some embodiments may set the value of the filtered estimate FE to the value of previous filtered estimate PFE, or the value of the filtered estimate FE may simply remain unchanged.

If, on the other hand, the estimated error does not exceed the specified threshold, some embodiments may set K_{PART} to a value that is a function of the estimated error and/or the previous maneuvers associated with the previous filtered estimate PFE. For example, if the previous filtered estimate PFE incorporates a previous estimate corresponding to a full turn, some embodiments may set K_{PART} to a relatively low value (e.g., in the range of 0.15 to 0.25). Setting K_{PART} to a relatively low value under these conditions may reflect a judgment that a somewhat stale wind estimate associated with a full turn may be more accurate than a more recent wind estimate associated with a partial turn. Filter gain values at the higher end of the range may correspond to low estimated error values, while filter gain values at the lower end of the range may correspond to high estimated error values.

As another example, if the previous filtered estimate PFE does not incorporate a previous estimate corresponding to a full turn, but does incorporate a previous estimate corresponding to a partial turn, some embodiments may set K_{PART} to a moderate value (e.g., in the range of 0.45 to 0.55). Setting K_{PART} to a moderate value under these conditions may reflect a judgment that when multiple partial turns are performed an no full turn is performed, an accurate estimate of the wind vector can be obtained by averaging the preliminary estimates corresponding to the partial turns. As in the previous scenario, filter gain values at the higher end of the range may correspond to low estimated error values, while filter gain values at the lower end of the range may correspond to high estimated error values.

As yet another example, if the previous filtered estimate PFE does not incorporate a previous estimate corresponding to a full or partial turn, but does incorporate a previous estimate corresponding to steady-straight flight, some embodiments may set K_{PART} to a high value (e.g., in the range of 0.95 to 1.00). Setting K_{PART} to a high value under these conditions may reflect a judgment that any preliminary estimate corresponding to partial turn is likely to be more accurate than a previous filtered estimate associated only with wind vectors corresponding to steady-straight flight. As in the previous scenarios, filter gain values at the higher end of the range may correspond to low estimated error values, while filter gain values at the lower end of the range may correspond to high estimated error values.

As yet another example, if no previous filtered estimate has been provided, the value of the filtered estimate may be set to the value of the preliminary estimate.

After obtaining a preliminary estimate of a wind vector corresponding to steady-straight flight, some embodiments of estimation filtering unit 504 may set the value of the filtered estimate to a weighted sum of the preliminary estimate and a previous value of the filtered estimate (i.e., FE=K_{PART}*PE+(1−K_{PART})*PFE). In some embodiments, the value of the filter gain K_{SS} may depend on whether wind vectors corresponding to full turns, partial turns, and/or steady-straight flight have been incorporated into the previous filtered estimate.

For example, if the previous filtered estimate PFE incorporates a previous estimate corresponding to a full turn, some embodiments may set K_{SS} to an extremely low value (e.g., in the range of 9*10⁻⁴-9*10⁻⁵). As another example, if the previous filtered estimate PFE does not incorporate a previous estimate corresponding to a full turn, but does incorporate a previous estimate corresponding to a partial turn, some embodiments may set K_{SS} to a slightly higher value (e.g., in the range of 9*10⁻³-9*10⁻⁴). Setting the filter gain K_{SS} to such low values under these conditions may reflect a judgment that wind estimates corresponding to full and partial turns are likely to be much more accurate than wind estimates corresponding to steady-straight flight.

As yet another example, if the previous filtered estimate PFE does not incorporate a previous estimate corresponding to a full or partial turn, but does incorporate a previous estimate corresponding to steady-straight flight, some embodiments may set K_{SS} to a somewhat higher value (e.g., in the range of 1*10⁻²-9*10⁻²). Setting the filter gain K_{SS} in this manner may reflect the judgment that, despite any inaccuracies of individual wind estimates corresponding to steady-straight flight, filtering hundreds of estimates corresponding to steady-straight flight may provide an accurate estimate of a wind vector.

In some embodiments, estimation filtering unit 504 may adjust the manner in which a filtered estimate FE is calculated in accordance with conditions experienced by the aircraft. For example, while wind vectors at a given altitude may be relatively stable for short periods of time (e.g., one to two hours), wind vectors at different altitudes may differ significantly. Accordingly, if the aircraft changes altitude by more than a threshold amount (e.g., 100 feet), estimation filtering unit may increase the filter gains associated with preliminary estimates of the wind vector at the new altitude and decrease the filter gains associated with previous values of the filtered estimate, thereby allowing the filtered estimate FE to more quickly change to reflect the new wind conditions at the new altitude.

In some embodiments, the filtering calculation applied by estimation filtering unit 504 may have an associated time constant. Under most conditions, the time constant may be fairly short (e.g., on the order of seconds or tens of seconds). However, some embodiments may configure the filtering unit 504 to use a fairly long time constant (e.g., on the order of hundreds or thousands of seconds) under specified conditions, such as when the aircraft experiences light winds. Light winds may be regarded as wind having a magnitude below a specified threshold, such as 2 knots. In accordance with Eq. 4, when an aircraft experiences light winds, the estimated wind direction may be highly sensitive to small variations in the magnitudes of the estimated north and east wind components. Thus, configuring the filtering unit to use a long time constant under light-wind conditions may stabilize the estimated wind direction reported by the estimation filtering unit 504.

In summary, embodiments of wind estimation unit 400 may use a maneuver detection unit 402 and a wind sample calculation unit 404, respectively, to detect whether the aircraft is performing a maneuver, such as full turn, a partial turn, or steady-straight flight, and to calculate wind vector samples corresponding to such maneuvers. In addition, embodiments may use an estimation unit 406 to estimate a wind vector corresponding to a wind condition prevailing near the aircraft, based on the wind vector samples.

Embodiments of wind estimation unit 400 may be implemented as software, hardware, or a combination thereof. Likewise, components of wind estimation unit 400 (e.g., maneuver detection unit 402, wind sample calculation unit 404, estimation unit 406, preliminary estimation unit 502, and/or estimation filtering unit 504) may be implemented as software, hardware, or a combination thereof. For example, any or all of the above-described units may be implemented as instructions executing on a processor of a computer, such as the exemplary computer illustrated in FIG. 7.

FIG. 7 is a schematic illustration of an exemplary embodiment of a computer 700. The exemplary computer 700 of FIG. 7 comprises one or more memories 702 and one or more processors 704 coupled to a communication bus 710. The memory 702 may be random-access memory (RAM), read-only memory (ROM), disc-based memory, solid-state memory, or any other device known to one of ordinary skill in the art or otherwise suitable for storing instructions and/or data in a non-transient manner. The memory 702 may store instructions which, when executed by the processor(s) 704, cause the processor(s) 704 to perform the functions of a wind estimation unit 400, maneuver detection unit 402, wind sample calculation unit 404, estimation unit 406, preliminary estimation unit 502, and/or estimation filtering unit 504.

The exemplary computer 700 of FIG. 7 may further comprise an input/output interface 706 and/or a network interface 708. Computer 700 may receive flight parameter values measured (or “sampled”) by various sensors via I/O interface 706 or network interface 708. In some embodiments, some or all of the flight parameter values may be stored, at least temporarily, in memory 702 in locations accessible to wind estimation unit 400.

Methods

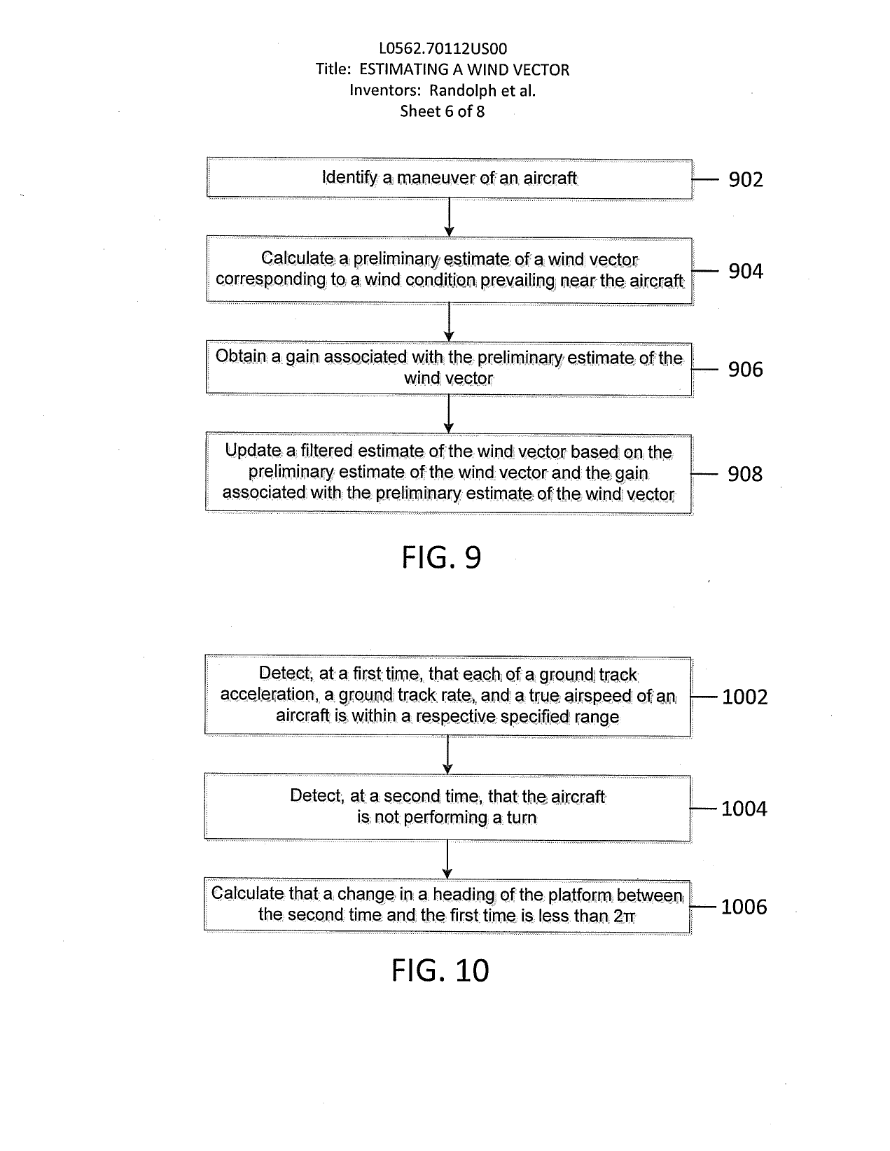

FIG. 9 depicts an exemplary method of calculating an estimate of a wind vector. At act 902 of the exemplary method, a maneuver of an aircraft is identified. In some embodiments, the identified maneuver may comprise a steady-straight motion maneuver, a partial turn, or a full turn. In some embodiments, the identified maneuver may comprise one or more additional aircraft maneuvers known to one or ordinary skill in the art. Also, the motion of the aircraft may not always correspond to an identifiable maneuver. That is, at a given time, the aircraft may perform a maneuver which is identified at act 902 as not corresponding to a steady-straight motion maneuver, a partial turn, a full turn, or any additional aircraft maneuver known to one of ordinary skill in the art.

At act 904 of the exemplary method, a preliminary estimate of a wind vector corresponding to a wind condition prevailing near the aircraft is identified. In some embodiments, calculating the preliminary estimate may comprise applying a maneuver-specific wind estimation process to one or more measurements collected during the corresponding maneuver. For example, calculating the preliminary estimate may comprise using dead reckoning navigation to produce one or more wind vector samples from measurements of flight parameters corresponding to a full turn, and averaging the one or more wind vector samples to produce the preliminary estimate. As another example, calculating the preliminary estimate may comprise using dead reckoning navigation to produce one or more wind vector samples from measurements of flight parameters corresponding to a partial turn, fitting curves (e.g., sinusoids) to orthogonal components of the wind vector samples, projecting additional wind vector samples along each of the fitted curves, and averaging the wind vector samples and the projected additional wind vector samples along each of the fitted curves to produce preliminary estimates of the component wind vectors. As yet another example, calculating the preliminary estimate may comprise using dead reckoning navigation to produce a wind vector sample from measurements of flight parameters corresponding to steady-straight flight.

At act 906 of the exemplary method, a gain associated with the preliminary estimate of the wind vector is obtained. In some embodiments, the gain may be a filter gain. In some embodiments, the process of calculating the filter gain associated with the preliminary estimate may depend on a past or present state of the aircraft. For example, the filter gain may depend on the maneuver corresponding to the preliminary estimate, an estimated error in the preliminary estimate, one or more maneuvers previously performed by the aircraft and/or conditions experienced by the aircraft (such as changes in altitude or light winds).

At act 908 of the exemplary method, a filtered estimate of the wind vector may be updated. Updating the filtered estimate may comprise setting an initial value of the filtered estimate, or calculating a new value of the filtered estimate based on a preliminary estimate, a filter gain, and/or a previous value of the filtered estimate. For example, updating the filtered estimate of a wind vector may comprise setting the new value of the filtered estimate to the value of a preliminary estimate corresponding to a full turn. As another example, updating the filtered estimate may comprise setting the new value of the filtered estimate FE to a weighted sum of a preliminary estimate PE and a previous value of the filtered estimate PFE (e.g., FE=K*PE+(1−K)*PFE, where K is the filter gain associated with the preliminary estimate).

In some embodiments, updating the filtered estimate may comprise adjusting a time constant associated with the filter. For example, updating the filtered estimate may comprise increasing the time constant when the aircraft experiences light winds, and decreasing the time constant when the aircraft does not experience light winds.

FIG. 10 depicts an exemplary method of identifying a maneuver of an aircraft as a partial turn maneuver. At act 1002 of the exemplary method, the values of an aircraft's ground track turn acceleration, ground track turn rate, and average true airspeed are detected as being within respective ranges at a first time. For example, the range associated with the ground track turn acceleration range may be any value less than approximately 0.025 radians/second², the range associated with the ground track turn rate may be any value greater than approximately 0.01 radians/second, and the range associated with the average true airspeed may be any value greater than approximately 50.0 knots.

At act 1004 of the exemplary method, it is detected that the aircraft is not performing a turn at a second time. For example, termination of a turn maneuver may be detected if the value of the aircraft's ground track turn acceleration, ground track turn rate, or average true airspeed is detected as being outside a corresponding range, such as the range specified above with respect to act 1002. The second time may be later than the first time.

At act 1006 of the exemplary method, a change in the aircraft's heading between the second time and the first time is detected as being less than 2π radians. The change in the aircraft's heading between the second and first times may be measured or calculated using means known to one of ordinary skill in the art or any other suitable means.

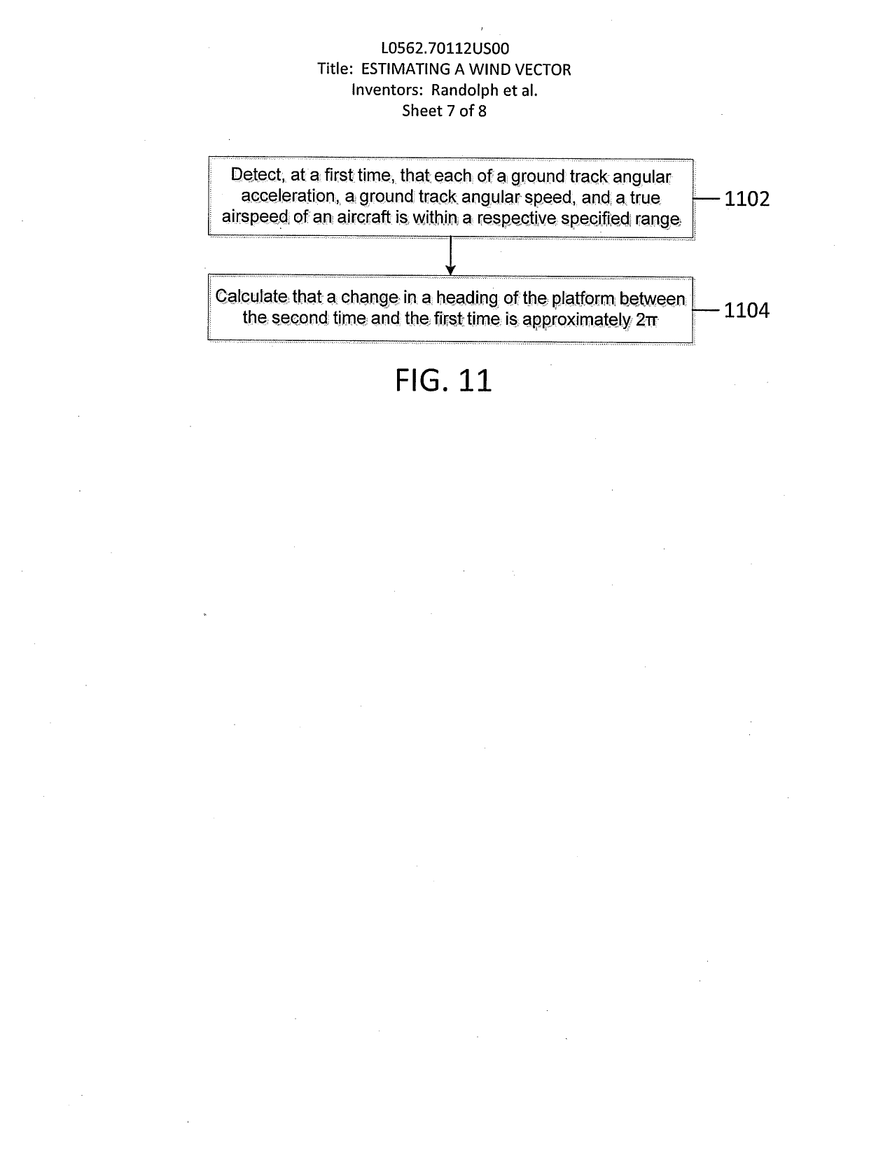

FIG. 11 depicts an exemplary method of identifying a maneuver of an aircraft as a full turn maneuver. At act 1102 of the exemplary method, the values of an aircraft's ground track turn acceleration, ground track turn rate, and average true airspeed are detected as being within respective ranges at a first time. For example, the range associated with the ground track turn acceleration range may be any value less than approximately 0.025 radians/second², the range associated with the ground track turn rate may be any value greater than approximately 0.01 radians/second, and the range associated with the average true airspeed may be any value greater than approximately 50.0 knots.

At act 1104 of the exemplary method, a change in the aircraft's heading between a second time and the first time is detected as being approximately 2π radians. The change in the aircraft's heading between the second and first times may be measured or calculated using means known to one of ordinary skill in the art or any other suitable means.

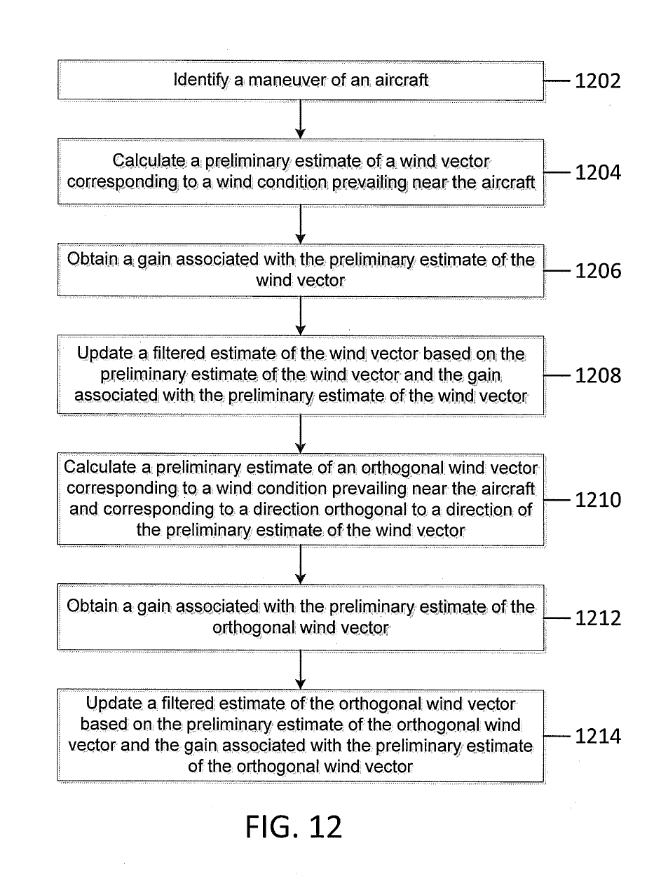

FIG. 12 depicts another exemplary method of calculating an estimate of a wind vector. Acts 902, 904, 906, and 908 of the exemplary method of FIG. 12 may be similar or identical to acts 1202, 1204, 1206, and 1208 of the exemplary method of FIG. 9, and will not be discussed further here.

At act 1210 of the exemplary method, a preliminary estimate of an orthogonal wind vector corresponding to a wind condition prevailing near the aircraft is identified. In some embodiments, the orthogonal wind vector may be orthogonal to the wind vector calculated in acts 1202-1208, such that the wind vector and the orthogonal wind vector are components of a net wind vector. For example, the wind vector may be a north wind vector, and the orthogonal wind vector may be an east wind vector. In some embodiments, calculating the preliminary estimate of the orthogonal wind vector may comprise applying a maneuver-specific wind estimation process to one or more measurements collected during the corresponding maneuver.

At act 1212 of the exemplary method, a gain associated with the preliminary estimate of the orthogonal wind vector is obtained. In some embodiments, the gain may be a filter gain. In some embodiments, the process of obtaining the filter gain associated with the preliminary estimate of the orthogonal wind vector may depend on the maneuver corresponding to the preliminary estimate, an estimated error in the preliminary estimate, and/or one or more maneuvers previously performed by the aircraft.

At act 908 of the exemplary method, a filtered estimate of the orthogonal wind vector may be updated. Updating the filtered estimate of the orthogonal wind vector may comprise setting an initial value of the filtered estimate of the orthogonal wind vector, or calculating a new value of the filtered estimate of the orthogonal wind vector based on a preliminary estimate of the orthogonal wind vector, a filter gain associated with the orthogonal wind vector, and/or a previous value of the filtered estimate of the orthogonal wind vector.

Miscellaneous

Having thus described several embodiments of this invention, it is to be appreciated that various alterations, modifications, and improvements will readily occur to those skilled in the art. For example, while embodiments of this disclosure have been described with reference to aircraft, one or ordinary skill in the art will understand that embodiments may be adapted to other mobile platforms such as water-based vehicles (e.g., sailboats) or to land-based vehicles (e.g., cars and trucks). In addition, some embodiments may include any features described as being part of any embodiment, even if the features are not expressly described above as being part of the same embodiment.

Such alterations, modifications, and improvements are intended to be part of this disclosure, and are intended to be within the spirit and scope of the invention. Further, though advantages of the present disclosure are indicated, it should be appreciated that not every embodiment includes every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology, may operate according to any suitable protocol, and may include wireless networks, wired networks or fiber optic networks.

Also, the various methods or processes outlined herein may be coded as software that is executable on one or more processors of computers that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments of this disclosure may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement various embodiments of this disclosure discussed above.

As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this disclosure, one or more computer programs that, when executed, perform embodiments of a disclosed method need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Also, the invention may be embodied as a method, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method of calculating an estimate of a wind vector, the method comprising:
identifying, with a processor, a maneuver of a platform, wherein the identified maneuver comprises one of a steady-straight motion maneuver, a partial turn maneuver, or a full turn maneuver;
calculating, with a processor, a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver;
calculating, with a processor, a gain associated with the preliminary estimate of the wind vector, the calculating of the gain associated with the preliminary estimate of the wind vector comprising applying a gain calculation process associated with a state of the aircraft; and
updating, with a processor, a filtered estimate of the wind vector based, at least in part, on the preliminary estimate of the wind vector and the gain associated with the preliminary estimate of the wind vector.

2. The method of claim 1, wherein the state of the aircraft comprises the identified maneuver, an estimated error in the preliminary estimate of the wind vector, one or more maneuvers previously performed by the aircraft, and/or conditions experienced by the aircraft.

3. The method of claim 1, wherein identifying the maneuver of the platform as the partial turn maneuver comprises:
detecting, at a first time, that each of a ground track turn acceleration of the platform, a ground track turn rate of the platform, and an average true airspeed of the platform is within a respective specified range;
detecting, at a second time, that the platform is not performing a turn; and
calculating that a change in a heading of the platform between the second time and the first time is less than 2π radians.

4. The method of claim 1, wherein identifying the maneuver of the platform as the full turn maneuver comprises:
detecting, at a first time, that each of a ground track turn acceleration of the platform, a ground track turn rate of the platform, and an average true airspeed of the platform is within a respective specified range; and
calculating that a change in a heading of the platform between a second time and the first time is approximately 2π radians.

5. The method of claim 1, further comprising:
calculating, with a processor, a preliminary estimate of an orthogonal wind vector, the orthogonal wind vector corresponding to a wind condition prevailing near the platform and corresponding to a direction orthogonal to a direction of the preliminary estimate of the wind vector, the calculating of the preliminary estimate of the orthogonal wind vector comprising applying the wind estimation process associated with the identified maneuver to one or more measurements collected during the identified maneuver;
calculating, with a processor, a gain associated with the preliminary estimate of the orthogonal wind vector, the calculating of the gain associated with the preliminary estimate of the orthogonal wind vector comprising applying the gain calculation process associated with the state of the aircraft; and
updating, with a processor, a filtered estimate of the orthogonal wind vector based, at least in part, on the preliminary estimate of the orthogonal wind vector and the gain associated with in the preliminary estimate of the orthogonal wind vector.

6. The method of claim 2, wherein the gain associated with the preliminary estimate of the wind vector depends, at least in part, on the estimated error in the preliminary estimate of the wind vector, and the estimated error depends, at least in part, on a type of the identified maneuver.

7. The method of claim 6, wherein:
the identified maneuver comprises the partial turn maneuver,
the estimated error in the preliminary estimate of the wind vector further depends, at least in part, on an estimate of a fit between data associated with the partial turn maneuver and data associated with a full turn maneuver, and
the estimate of the fit depends on a percentage of a full turn associated with the partial turn maneuver and on a phase of the full turn associated with the partial turn maneuver.

8. The method of claim 7, wherein the data associated with the full turn maneuver depends on the platform.

9. An apparatus for estimating a wind vector, the apparatus comprising:
a processor; and
a memory storing instructions which, when executed, cause the processor to perform a method of:
identifying a maneuver of a platform, wherein the identified maneuver comprises one of a steady-straight motion maneuver, a partial turn maneuver, or a full turn maneuver;
calculating a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver;
calculating a gain associated with the preliminary estimate of the wind vector, the calculating of the gain associated with the preliminary estimate of the wind vector comprising applying a gain calculation process associated with a state of the aircraft; and
updating a filtered estimate of the wind vector based, at least in part, on the preliminary estimate of the wind vector and the gain associated with the preliminary estimate of the wind vector.

10. The apparatus of claim 9, wherein the state of the aircraft comprises the identified maneuver, an estimated error in the preliminary estimate of the wind vector, one or more maneuvers previously performed by the aircraft, and/or conditions experienced by the aircraft.

11. The apparatus of claim 9, wherein identifying the maneuver of the platform as the partial turn maneuver comprises:
detecting, at a first time, that each of a ground track turn acceleration of the platform, a ground track turn rate of the platform, and an average true airspeed of the platform is within a respective specified range;
detecting, at a second time, that the platform is not performing a turn; and
calculating that a change in a heading of the platform between the second time and the first time is less than 2π radians.

12. The apparatus of claim 10, wherein the gain associated with the preliminary estimate of the wind vector depends, at least in part, on the estimated error in the preliminary estimate of the wind vector, and the estimated error depends, at least in part, on a type of the identified maneuver.

13. The apparatus of claim 12, wherein:
the identified maneuver comprises the partial turn maneuver,
the estimated error in the preliminary estimate of the wind vector further depends, at least in part, on an estimate of a fit between data associated with the partial turn maneuver and data associated with a full turn maneuver, and
the estimate of the fit depends on a percentage of a full turn associated with the partial turn maneuver and on a phase of the full turn associated with the partial turn maneuver.

14. The apparatus of claim 13, wherein the data associated with the full turn maneuver depends on the platform.

15. One or more computer-readable storage media storing instructions for controlling a computer to perform a method comprising:
identifying a maneuver of a platform, wherein the identified maneuver comprises one of a steady-straight motion maneuver, a partial turn maneuver, or a full turn maneuver;
calculating a preliminary estimate of a wind vector corresponding to a wind condition prevailing near the platform, the calculating of the preliminary estimate of the wind vector comprising applying a wind estimation process associated with the identified maneuver to one or more measurements collected during the identified maneuver;
calculating a gain associated with the preliminary estimate of the wind vector, the calculating of the gain associated with the preliminary estimate of the wind vector comprising applying a gain calculation process associated with a state of the aircraft; and
updating a filtered estimate of the wind vector based, at least in part, on the preliminary estimate of the wind vector and the gain associated with the preliminary estimate of the wind vector.

16. The one or more computer-readable storage media of claim 15, wherein the state of the aircraft comprises the identified maneuver, an estimated error in the preliminary estimate of the wind vector, one or more maneuvers previously performed by the aircraft, and/or conditions experienced by the aircraft.

17. The one or more computer-readable storage media of claim 15, wherein identifying the maneuver of the platform as the partial turn maneuver comprises:
detecting, at a first time, that each of a ground track turn acceleration of the platform, a ground track turn rate of the platform, and an average true airspeed of the platform is within a respective specified range;
detecting, at a second time, that the platform is not performing a turn; and
calculating that a change in a heading of the platform between the second time and the first time is less than 2π radians.

18. The one or more computer-readable storage media of claim 16, wherein the gain associated with the preliminary estimate of the wind vector depends, at least in part, on the estimated error in the preliminary estimate of the wind vector, and the estimated error depends, at least in part, on a type of the identified maneuver.

19. The one or more computer-readable storage media of claim 18, wherein:
the identified maneuver comprises the partial turn maneuver,
the estimated error in the preliminary estimate of the wind vector further depends, at least in part, on an estimate of a fit between data associated with the partial turn maneuver and data associated with a full turn maneuver, and
the estimate of the fit depends on a percentage of a full turn associated with the partial turn maneuver and on a phase of the full turn associated with the partial turn maneuver.

20. The one or more computer-readable storage media of claim 19, wherein the data associated with the full turn maneuver depends on the platform.
